(19) United States
(12) Patent Application Publication
(10) Pub. No.: US 2016/0092643 A1
(43) Pub. Date: Mar. 31, 2016

(54) SYSTEM AND PROCESS FOR PROVIDING VERIFICATION AND VALIDATION OF AN INDIVIDUAL'S IDENTITY

(71) Applicants: Robert Daniel Hinkle, Ashburn, VA (US); Elton Ray Williams, Round HIll, VA (US)

(72) Inventors: Robert Daniel Hinkle, Ashburn, VA (US); Elton Ray Williams, Round HIll, VA (US)

(21) Appl. No.: 14/865,690

(22) Filed: Sep. 25, 2015

Related U.S. Application Data
(60) Provisional application No. 62/056,050, filed on Sep. 26, 2014.

(51) Int. Cl. G06F 19/00

(52) U.S. Cl. CPC G06F 19/328

(57) ABSTRACT

A system and process for providing the recording of provided health care transactions to an individual and the verification and validation of both the recipient and provider's identities. More particularly, to a system and process for providing verification and validation of an individual's identity for use in the prevention of identity theft and fraud in the medical industry and the recording of all medical related treatments and record requests by authorized providers, among other features. The verification and validation, referred to as “Positive Identification (PI)” for an individual who is seeking or in need of medical diagnosis and/or treatment may include a collection of novel processes by which a person's PI may be obtained and captured in an electronic database each time a person's medical information is accessed or treatment is provided, and in full compliance with the Health Insurance Portability and Accountability Act (HIPAA) of 1996. This may substantially prevent fraud of medical services.

This application claims benefit and priority to U.S. Provisional Application No. 62/056,050; filed Sep. 26, 2014, the disclosure of which is incorporated by reference herein in its entirety.

### BACKGROUND OF THE DISCLOSURE

1.0 Field of the Disclosure

The present disclosure generally relates to a system and process for providing the recording of provided health care transactions to an individual and the verification and validation of both the recipient and provider's identities. More particularly, to a system and process for providing verification and validation of an individual's identity for use in the prevention of identity theft and fraud in the medical industry and the recording of all medical related treatments and record requests by authorized providers, among other features.

2.0 Related Art

Medicare and Medicaid, along with private insurance providers, appears to have lost close to $100 billion dollars in 2014. Developing a system to prevent medical fraud before it happens has proved elusive. Yet, a fraud prevention system would be far more effective than trying to track down the individuals, prosecute them, and recover the funds once they are fraudulently paid. In fact, that very process incurs its own costs, thereby diminishing the overall funds recovery effort.

As it currently stands, most insurance providers, hereinafter referred to as the “insurer”, simply check the identification provided by an individual—usually a State-issued driver's license or other identity card, to obtain Positive Identification (PI). The insurer then issues an insurer-specific medical card. Oftentimes, once a medical card is issued, no continuing PI is done as the medical card is used instead. Even when another identity card is used for PI they can be, and frequently are, forged by those who are seeking services fraudulently.

Caregivers are not incented to ensure the individuals they provide care for are indeed the individuals the insurer is covering, as payment is usually received regardless. Further, few caregivers would be willing to confront an individual as to the validity of their identity.

Complicating matters even further is the fact that caregivers are not often, if ever, linked together, or otherwise able to be associated with one another for a given individual. There are approximately 230,187 physician practices in the United States. Among these physician practices, 52.8% consist of only one office-based physician. The remaining 47.2% of physician practices are group practices. Physician group practices with 2-5 physicians make up 37.1% of physician offices in the United States. Of those offices, 6.3% consist of 6-9 physicians and the remaining 3.7% consist of 10 or more physicians.

Currently, the focus remains primarily on recovery of costs of fraudulent claims. If a solution that reduces fraudulent claims and/or improves health services while preventing fraud can be provided, this would be an advancement in the medical industry.

### SUMMARY OF THE DISCLOSURE

The disclosure addresses the shortcomings of the prior art and provides improved benefits. In one aspect, the present disclosure includes a system and process to provide a better solution for preventing fraudulent claims and to better assure proper identification for services rendered.

In one aspect, a system and process is provided for providing verification and

validation of an individual's identity and, more particularly, to a system and process for providing verification and validation of an individual's identity for use in the prevention of identity theft and fraud in the medical industry, and the recording of all medical-related treatments and record requests by authorized providers, among other features. The verification and validation, referred to as “Positive Identification (PI)” for an individual who is seeking or in need of medical diagnosis and/or treatment, may include a collection of novel processes by which a person's PI may be obtained and captured in an electronic database each time a person's medical information is accessed or treatment is provided, and in full compliance with the Health Insurance Portability and Accountability Act (HIPAA) of 1996.

In one aspect, a system for providing verification and validation of an enrolled individual is provided comprising a device encoded with a QR code to identify an enrolled individual; wherein the enrolled individual has been positively identified, a reader to read the QR code, a computer to receive the QR code data, a first personal identification code (PIN) or other PI method such as biometrics, singularly or collectively and hereinafter collectively referred to as a unique identifier (UI) associated with the enrolled individual and a second UI associated with at least one enrolled health care service provider, and the database accessible by the computer to verify the unique identifier of an individual contained within the QR code, the first UI and the second UI and to store data related to at least one encounter between the enrolled individual and the enrolled at least one health care service provider, and the database configured to be accessed by the computer to recover and output historical data related to the encounter between the enrolled individual and the enrolled at least one health care service provider. The enrolled health care service provider may comprise a plurality of health care service providers, each of the plurality of health care service providers having a separate and unique UI, each encounter by each of the plurality of enrolled health care service providers with the enrolled individual being recorded in the database. The stored data related to the at least one encounter may include at least one of: type of service, date, time, location, QR code scanning device ID, QR code scanning device software ID, QR code data, first UI, and second UI. The database may store data related to a plurality of encounters between the enrolled individual and a plurality of one enrolled health care service providers. The stored data may include: type of service, date, time, location, QR code scanning device ID, QR code scanning device software ID, QR code data, first UI, and second UI. The computer may comprise a software component to verify the first UI and the second UI. The database may be configured to be accessed by the computer to recover historical data related to all encounters between the enrolled individual and a plurality of enrolled health care service providers. The system may further include a global positioning system (GPS) device to identify a location of the at least one encounter.

In one aspect, a system for providing verification and validation of an identity of at least one enrolled individual comprising a device encoded with a QR code or near-field data to identify an enrolled individual; wherein the enrolled individual has been positively identified biometrically, a reader to read the QR code or near-field data, a computer to receive the QR code or near-field data, a first UI associated with the enrolled individual and a plurality of second UIs associated with a plurality of enrolled health care service providers, and the database accessible by the computer to verify the QR code, the first UI and the plurality of second UIs and to store data related to a plurality of encounters between the enrolled individual and a plurality of enrolled health care service providers, and the database configured to be accessed by the computer to recover and output historical data related to the encounter between the enrolled individual and the plurality of enrolled health care service provider. Each of the plurality of enrolled health care service providers may have a separate and unique UI, each encounter by the plurality of enrolled health care service providers with the enrolled individual being recorded in the database. The stored data related to the plurality of encounters may include at least one of: type of service, date, time, location, QR code scanning device ID, QR code scanning device software ID, QR code data, first UI, and second UI. The device may be selected from the group comprising: a cell phone, a mobile electronic device, a wearable device, a card, a personal ID badge, a wearable electronic device and an electronic watch. The database may be configured to be accessed by the computer to recover historical data related to all encounters between a plurality of enrolled individuals and a plurality of enrolled health care service providers.

In one aspect, a method for providing verification and validation of an identity of at least one enrolled individual comprises encoding with a QR code to identify an enrolled individual; wherein the enrolled individual has been positively identified, reading the QR code during an encounter with at least one enrolled health care service provider, receiving at a computer the QR code data, a first UI associated with the enrolled individual and a second UI associated with at least one enrolled health care service provider and accessing a database accessible by the computer to verify the individual's unique identifier contained within the QR code, the first UI and the second UI and to store data related to at least one encounter between the enrolled individual and the at least one enrolled health care service provider, and wherein the database is configured to be accessed by the computer to recover and output historical data related to the encounter between the enrolled individual and the at least one enrolled health care service provider. The at least one enrolled health care service provider may comprise a plurality of enrolled health care service providers, each of the plurality of enrolled health care service providers having a separate and unique UI, each encounter by each of the plurality of enrolled health care service providers with the enrolled individual being recorded in the database. The stored data related to the at least one encounter may include at least one of: type of service, date, time, location, QR code scanning device ID, QR code scanning device software ID, QR code data, first UI, and second UI.

In one aspect, a computer program product comprising a non-transitory storage medium embodying the software logic for providing verification and validation of an identity of at least one enrolled individual, the software logic configured that when read and executed by a computer processor, performs the following: encoding with a QR code or near-field data on a user device to identify an enrolled individual; wherein the enrolled individual has been positively identified, reading the QR code or near-field data during at least one encounter with a plurality of enrolled health care service providers, receiving at a computer the QR code data or near-field data, a first UI associated with the enrolled individual and a second UI associated with a least one of the plurality of enrolled health care service providers and accessing a database accessible by the computer to verify the individual's unique identifier contained within the QR code or near-field data, the first UI and the second UI and to store data related to at least one encounter between the enrolled individual and the at least one of the plurality of enrolled health care service providers, and wherein the database is configured to be accessed by the computer to recover and output historical data related to the encounter between the enrolled individual and the at least one of the plurality of enrolled health care service providers.

### BRIEF DESCRIPTION OF THE DRAWINGS

FIG. 1A is an illustrative block diagram of a system for creating a QR code and establishing PI, configured according to principles of the disclosure;

FIG. 1B is an illustrative block diagram of a system for using the QR code, configured according to principles of the disclosure;

FIG. 1C is an illustrative block diagram of a system for using a near-field communication technique, configured according to principles of the disclosure;

FIG. 2 is an example flow diagram of a process related to an emergency incident process, the steps performed according to principles of the disclosure;

FIG. 3 is an example of a flow diagram showing a process associated with a non-emergency incident, the steps performed according to principles of the disclosure.

FIG. 4 is a flow diagram showing an example process, the steps performed according to principles of the disclosure; and

FIG. 5 is an example process, the steps performed according to principles of the disclosure.

### DESCRIPTION OF THE DISCLOSURE

The disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the principles of the disclosure. Accordingly, the examples herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include a computing device, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), a cellular network, any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like. Online refers to and includes activity on a network by connected users of the network.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (e.g., instructions) which may be read by a computer. The computer-readable medium may be non-transitory. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

This present disclosure relates to a system and method for the verification and validation, hereinafter referred to as “Positive Identification (PI)”, for an individual who is seeking or in need of medical diagnosis and/or treatment. In particular, it includes a collection of novel processes by which a person's PI may be obtained and captured in an electronic database each time a person's medical information is accessed or treatment is provided, and in full compliance with the Health Insurance Portability and Accountability Act (HIPAA) of 1996. In this manner, all service providers such as, e.g., emergency responders, emergency room personnel, doctors, nurses, technicians, administrators, aids, and the like, even if these service providers are not normally associated with one another or under a common service entity, may be positively identified when providing services to an individual and such interaction being recorded in a common centralized database so that a complete history of interactions by service providers is maintained for later recall, review, verification of facts, and the like.

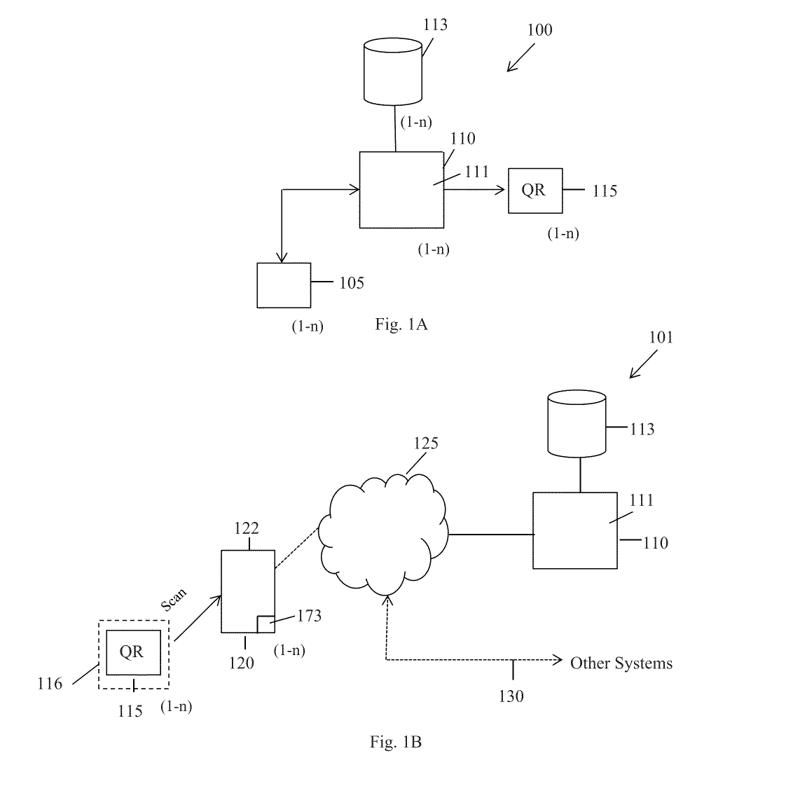

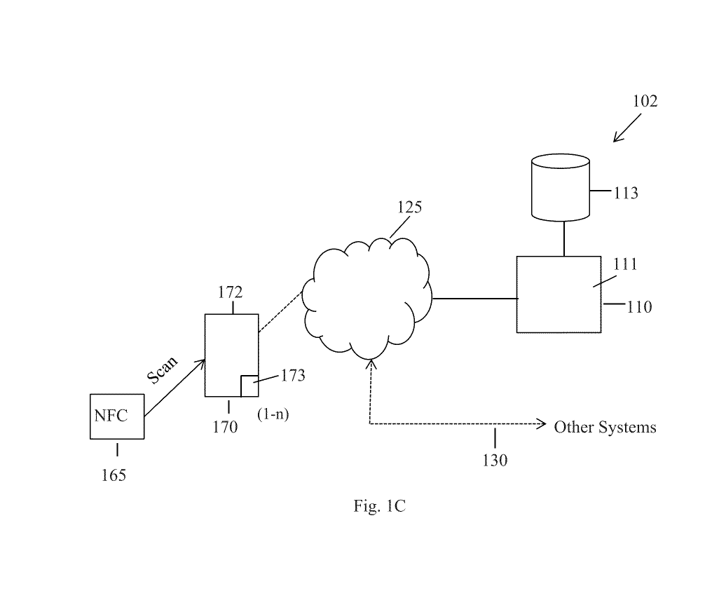

FIG. 1A is an illustrative block diagram of a system for creating a QR code and establishing PI, configured according to principles of the disclosure. The system 100 comprises at least one input device 105 for use by a user for enrolling an individual for eventually creating a QR code 115 for the enrolled individual. The user device 105 may be a personal computer, a mobile electronic device, a cell phone, a wearable device (e.g., an Apple Watch™), or the like. The system 100 may also include at least one computer 110 which may be a server controlling a website 111 connected to the input device 105, which may be over a network such as the Internet. Positive proof, e.g., multiple forms of ID which may include a picture ID of the individual, is required for enrolling the individual. Upon successful PI, a QR code, which may be physically embodied on a user input device 116 (which may or may not be the same as device 105) such as, e.g., on a card, plastic type badge, within a personal wearable device, within a mobile device, within a cell phone, or other physical device, is produced by the system 100, as described more fully below. The computer 110 may be connected to one or more databases 113 for storing a plurality of enrolled individuals, along with their medical information and to store transactional data captured during various processes described herein. The one or more databases 113 may store the individual's PI each time the individual's medical information is accessed or treatment is provided, as described more below.

FIG. 1B is an illustrative block diagram of a system for using the QR code, configured according to principles of the disclosure. The system 101 may comprise the at least one computer 110, database 113, at least one QR reader 120 for reading the QR code 115 and/or an optionally a global positioning system (GSP) device for location determination. In some applications, the QR reader 120 may be mobile and location of its use may be recorded along with any QR scan. In some embodiments, the at least QR reader 120 may be embodied on a computer, a separate mobile device, or other computing device suitable for the environment related to a service provider. The system 101 contemplates that each member service provider would be equipped with at least one QR reader 120. For example, each emergency transport vehicle may be equipped with at least one QR reader 120. Likewise, an urgent care facility, emergency room, hospital unit or room may also be equipped with at least one QR reader 120, as service environments warrant. The system 101 may include a network 125 which may be a wireless or wired network that may connect the at least one reader 120 with the at least one computer 110 and at least one database 113 via a communication link. In some situations, the at least one reader 120 may be disconnected at times and may function independently without connectivity to the network 125. The at least one computer 110 may be in communication with other systems via a communication link 130.

FIG. 1C is an illustrative block diagram of a system for using a near-field communication technique, configured according to principles of the disclosure. The system 102 may comprise the at least one computer 110, database 113, a near-field device 165 configured to convey personalized information related to a user of the near-field device 165 using near-field communications techniques. Near field communication (NFC) includes a set of protocols that enable electronic devices to establish radio communication with each other by touching the devices together, or bringing them into proximity to a distance of, e.g., 10 cm or less. The near-field device 165 may comprise, but not limited to, a card, a personal ID badge, a user device, a wearable device (e.g., an Apple Watch™), or similar devices. The system 102 may include a network 125 which may be a wireless or wired network that may connect the at least one reader 170 with the at least one computer 110 and at least one database 113 via a communication link. The at least one near-field reader 170 may optionally include a global positioning system (GSP) device 173 for location determination. The at least one near-field reader 170 may be embodied in another device such as a mobile computing device or computer-based device. In some applications, the at least one reader 170 may be mobile and location of its use may be recorded along with any scanned data. In some situations, the at least one reader 170 may be disconnected at times and may function independently without connectivity to the network 125. The at least one computer 110 may be in communication with other systems via a communication link 130. The at least one near-field reader 170 may be configured with a software application 172 to receive a near-field transmission via the at least one reader 170 from the near-field device 165 and for conveying such received information across the network 125 to the at least one computer 110 for processing of the received information. The received information includes near-field data (i.e., data equivalent to the enrolled individual data associated with the QR code) to identify an individual associated with the near-field device 165, and who has been previously positively identified and recorded, such as recorded in database 113. Near-field data may be usable in a like manner as a QC code as described below.

The QR Code may be customized and created as necessary for an enrolled individual and is a specialized, secure, QR Code that may be read by a reader application designed specifically to read the customized QR Code by the QR reader 120. The electronic database 113 is configured to store the transactional data captured during the various processes, and the processes that determine what data is captured and what information is provided to a medical service provider.

The enrollment process begins with the assignment of a custom QR code that is permanently assigned to each individual who enrolls in the system 100, 101. The QR code is only assigned after an individual provides proof of identity. Proof of identity requires multiple forms of identification, including at least one form having a photograph of the individual.

The QR code's content as created, except for the individual's unique identifier and full name, is determined by the individual and may be selected from a list of medical data located on a secure website 111 that the individual may access when they enroll or modify their selection(s). The selected data may also be stored on database 113. Data that can be stored and retrieved from the QR code itself (likewise, stored near-field information) includes, but is not limited to:
1) Unique individual identifier—this is required/defined and is not user definable.
2) Full name of individual
3) Address of individual
4) In case of emergency (ICE) contact name and contact information
5) Medical Information needed in case of emergency such as:
   a) Blood Type
   b) Allergies
   c) Current Medications and Dosages being taken by the individual
   d) Contact Information for the individual's primary care physician or other specialists

The QR code can be carried by the enrolled individual and made available to medical service providers, hereinafter referred to as “caregiver(s)” whenever diagnosis or treatment, hereinafter referred to as “service(s)”, are requested or needed.

There are two envisioned situation(s) or incident(s) in which the system and process of this disclosure may be employed: a) Emergency and b) Non-Emergency (Routine).

Within the Non-Emergency (Routine) incident, there are three situational employments anticipated: a) Positive Identification, b) Electronic Medical Record (EMR) request(s) and transmittal(s), and c) Diagnosis and Treatment Tracking. When all three Non-Emergency employments are used in series, they may comprise the entirety of the Non-Emergency situation's process.

Other situations or incidents may be suited for use of this system 100, 101, 102 and related processes. The identification and definition of the two example situations is not meant to restrict other uses.

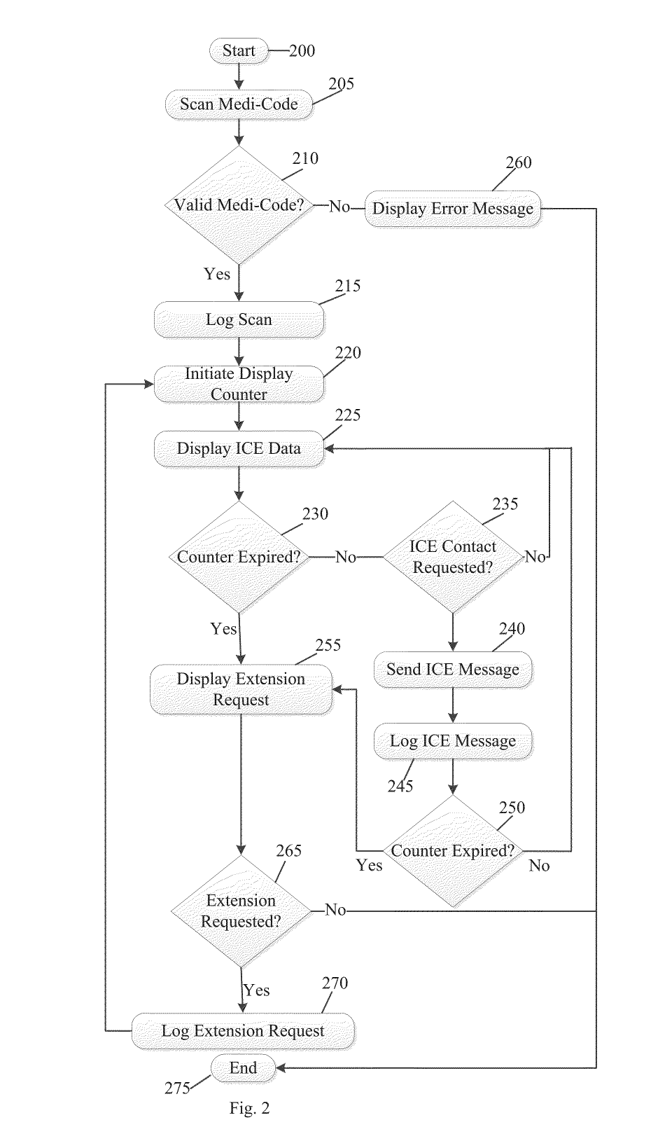

An example situation/incident is described below by process flow charts of FIGS. 2-5. The flow charts of FIGS. 2-5 may also represent block diagrams of the components for performing the respective steps. The components may be software logic embodied on a memory, computer-readable medium, or storage medium. The memory or storage medium may be non-transitory computer-readable devices. The software logic may be read from the memory or storage medium and executed by an appropriate computer processor that performs the respective step. The components may be embodied on the memory (e.g., a disc, ROM, CD/DVD, memory device, or the like) and may comprise a computer program product.

FIG. 2 is an example flow diagram of a process related to an emergency incident process, the steps performed according to principles of the disclosure, starting at step 200. At step 205, a caregiver may scan the individual's QR code using an application 122 designed to read the encoded data on a reader 120. The scan may be performed before or after service is rendered, or, both before and after. The application 122 (also known as the Medi-Vault application, hereinafter referred to as “the app”) attempts to read the QR code.

At step 210, if the code is valid,

Step 215, the scan is logged which may include GPS information and,

Step 220, an internal display counter is initiated and,

Step 225, the individual's ICE data is displayed on the requestors device and,

the ICE data transmission is logged and,

At step 230, the internal display counter is checked for expiration and,
if expired, continue to step 255, otherwise if not expired, then at step 235,
an ICE contact notification is requested then;
   At step 240, the ICE contact message is attempted to be sent,
   At step 245, the ICE contact notification request is logged and
   the ICE contact message request is logged and,
      if the ICE contact message is sent successfully then,
         an information message is displayed on the requestors device confirming the ICE contact message was successfully sent to the ICE contact.
      if the ICE contact message is not successfully sent then,
         an information message is displayed on the requestor's device
         notifying the requestor that the ICE contact message was not successfully sent and,
         the attempt at sending the ICE contact message is logged,
         then the requestor may be prompted to answer if they wish to continue to attempt to send the ICE contact message or,
         to cancel the ICE contact message and,
         the response to the resend question is logged.
         if the response is to continue to attempt to send the ICE contact message then,
         the response may be logged and,
         the requestor is asked, via a dialog box displayed on their device, how long the app should try to resend and,
         the response to the dialog box is logged and,
         a resend message timer is initiated and,
         the app attempts to send the ICE contact message until the timer expires at step 250 or the ICE contact message is successfully sent.
      if the response is to cancel the ICE contact message then;
         the response may be logged and no further action is taken.
   if at step 230, the display counter is expired then;
   at step 255, an information message may be displayed on the requestors device asking the requestor if they wish to continue viewing the ICE data and,
      if, at step 265, the response is “yes”, then;
      at step 270, the response to the continue viewing question may be logged and,
         the display counter may be initiated.
      Otherwise, if the response is “no”, then;
         the app may clear the screen of the requestors device and,
         the app may terminate at step 270.

if at step 210, the code is not valid or cannot be read then;
At step 260, an error message may be displayed on the scanning device and, the app may terminate at step 275.

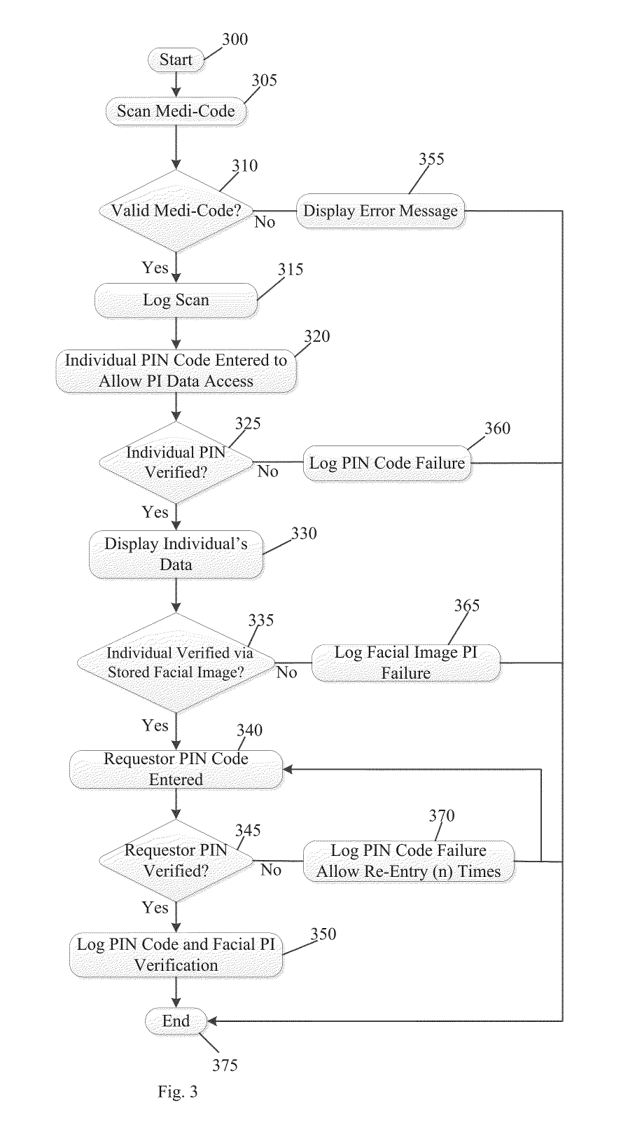

FIG. 3 is an example of a flow diagram showing a process associated with a non-emergency incident, the steps performed according to principles of the disclosure, starting at step 300. The term “requestor” may refer to a medical provider, caregiver, or the like. The process of FIG. 3 may include near-field data in lieu of a QR code in accordance with FIG. 1C. The process of FIG. 3 is described using QR codes, but is the same for using near-field data. At step 305, a caregiver may scan the individual's QR code using the application 122 designed to read the encoded data. The app 122 attempts to read the QR code.

If, at step 310, the code is valid,
the scan is logged at step 315 which may include GPS location information and,
at step 320 the individual is prompted to enter their UI to allow access to their PI data and,
if at step 325 the individual's UI is verified then;
   at step 330, the individual's PI data, is displayed on the requestor's device (e.g., device 120) then;
   at step 325, the requestor is asked to verify that the individual presenting the QR code is the same individual displayed on the requestor's device and,
   at step 335, if the requestor visually confirms the identity of the individual then;
      at step 340, the requestor is prompted to enter their UI and,
      if at step 345 the requestor UI is verified then;
         at step 350, the UI confirmation and visual PI are logged and,
         the app terminates at step 375.
      if at step 345 the requestor UI is not verified then;
         at step 370 the requestor is prompted, up to a specified number of attempts, to enter their UI. Each attempt is logged and,
         if the specified number of attempts are made without success then;
         the app terminates at step 375.
   if at step 335 the requestor cannot visually confirm the identity of the individual then;
      at step 365, the failure to PI the individual is logged and,
      the app terminates.
if at step 325 the individual UI is not verified then;
   at step 360 the failure to verify the individual's UI is logged and, the app terminates at step 375.

If at step 310 the code is not valid or cannot be read then;

At step 355, an error message is displayed on the scanning device and,
the app terminates at step 375.

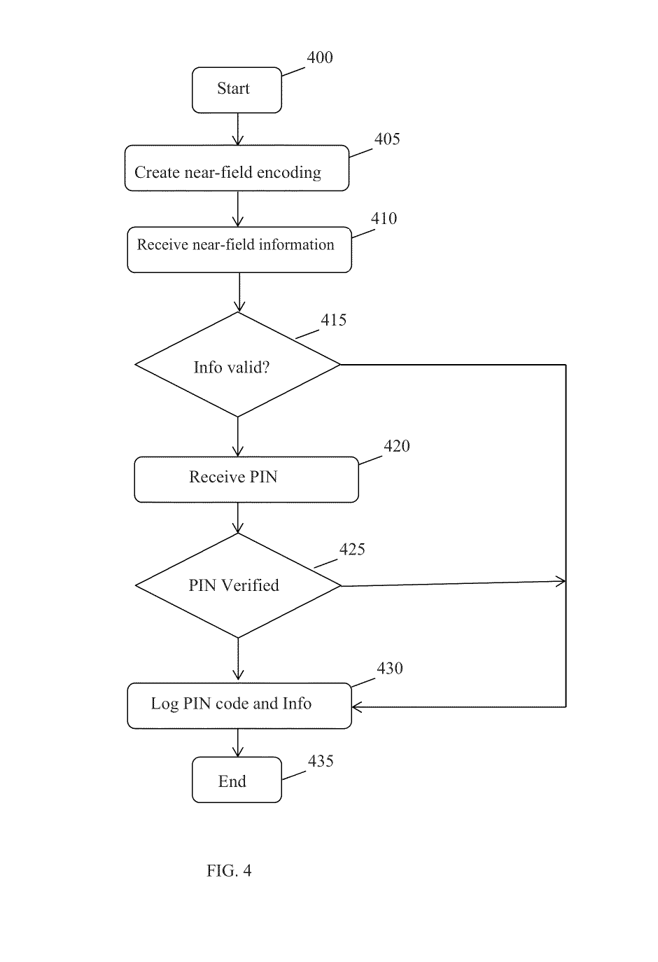

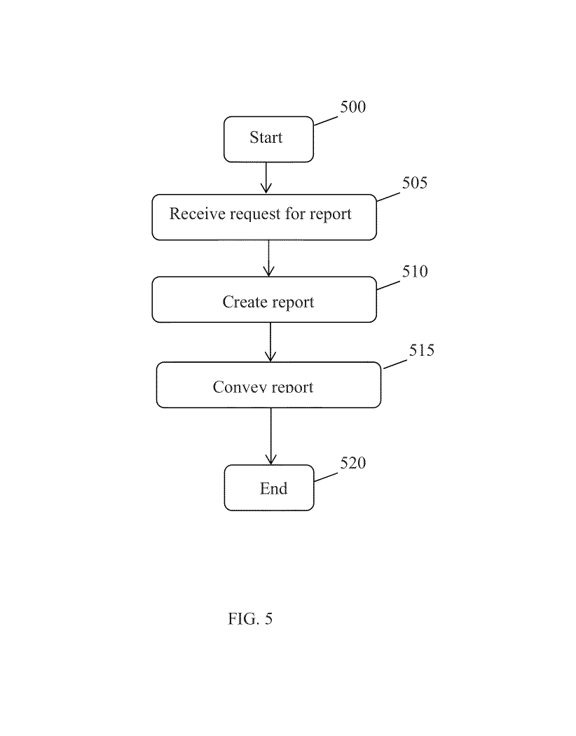

FIG. 4 is a flow diagram showing an example process, the steps performed according to principles of the disclosure, starting at 400. At step 405, near-field transmittable data may be created to positively identify an individual, such as a caregiver or similar medical service provider. This data may be verified in accordance with a process as similarly described above in FIGS. 2 and 3. This near-field data may be embodied in or on a card, plastic type badge, within a personal wearable device, within a mobile device, within a cell phone, or in or on another physical device. At step 410, during a service incident involving an individual and a service provider, the near-field data may be scanned to read data encoded thereon. At step 415, the read data may be verified. This may include accessing a record in database 113 for confirmation. At step 420, a UI may be requested from the individual so that access to the read data may occur. This step may be performed in conjunction with step 415. An UI may also be requested from the service provider for identification of the service provider. At step 425, the UI of each party, the individual and the service provider, may be verified. This may also include a visual verification by the service provider of the identity of the individual, such as by photo ID. At step 430, the UI and related information such as, e.g., location, time, service provider, and individual's identity may be logged at database 113. In some embodiments, the nature of the service rendered may be recorded/logged. The process may be at step 435.

FIG. 5 is an example process, the steps performed according to principles of the disclosure, beginning at step 500. At step 505, a request for a report based on parameters from databases 113 may be received by computer 110, perhaps from a manager or operator of the system 100, 101, 102. The parameters may include one or more (but not limited to) of: identities of an individual seeking medical service or having medical service rendered whose information has been previously recorded in database 113, a QR code, near-field data associate with an individual or service provider, identities of one or more service providers involved in caregiving for an individual, a time, a date, a location, a type of service, combinations thereof, or the like. The report may be conveyed as an output, either physically or in electronic format. The report may be produced as a result of a request by an individual or a service provider. The report may also be generated as part of a legal proceeding. The report may provide a historical basis of who was involved in one or more service events for an individual. The report may provide historical dates, times, locations, treatments, services, by each and all parties involved, e.g., (the individual receiving service, caregivers, medical personnel, technicians, staff, etc.). Moreover, the parties involved in a report are known to have had their identities positively verified and was known and recorded by the system 100, 101, 102 at the time of each recorded event. The parties involved may be unrelated to one another (e.g., a medical transport and a hospital), but may have a common individual for which services were rendered. The database 113 may record all service encounters with the individual with the IDs positively known and verified of those rendering services and the individual receiving services.

The system 100, 101, 102 may record services rendered including when the service was provided, e.g., at a certain time/date (such as, e.g., by GPS, or by a scanning device with a pre-known location) and each party involved recorded. For example, if an enrolled individual may enter a hospital, for each encounter with a medical provider (e.g., nurse, technician, doctor, administrator or the like), the individual receiving service would be positively verified by the QR code (or near-field data) and each of the parties (e.g., nurse, technician, doctor, administrator or the like), involved in the encounter would be logged.

As an alternative, instead of a QR code, a RFID tag might be employed instead. The RFID tag would be created with an enrolled individual's information and subsequently used as the QR code as described herein, with a RFID reader being involved.

As an alternative, instead of a QR code or RFID tag, a near field data application might be employed. The near field data application would be created with an individual's information and subsequently used as the QR code as described herein, with a near field data exchange being involved.

In some embodiments, the QR reader 120 and/or near-field reader 170 may be configured to hold or buffer scanned data until the scanned data can be successfully transmitted. That is, the scanning device(s), e.g., the QR reader 120 and/or near-field reader 170 need not be online at the time of the scan. The data may be stored locally until the transaction data can be successfully transmitted. Moreover, in one embodiment, the scanning device's (e.g., the QR reader 120 and/or near-field reader 170) resident software application may be configured to perform the basic PI function without need of the computer 110. That is, the verification and validation of an enrolled individual and/or enrolled healthcare service provider may be performed by the scanning device (e.g., the QR reader 120 and/or near-field reader 170) without interaction with computer 110.

The system and methods described herein permits individuals receiving medical services and/or treatments to have all their encounters with each and every service provider recorded in a common repository such as, e.g., database 113 In this manner, each individual service provider may have incident data recorded including their identity along with, e.g., date, time, QR code scanning device ID, QR code scanning device software ID, QR code data, first UI, and second UI, service rendered, and location of such service. This incident data may be later recalled as needed for a historical view into, e.g., an individual's service encounters.

While the disclosure has been described by way of illustrative examples, those skilled in the art will recognize that the principles of the disclosure can be practiced with modifications and in the spirit and scope of the appended claims. If there are any conflicts between this disclosure and any priority document, then this disclosure governs.

What is claimed is:

1. A system for providing verification and validation of an identity of at least one enrolled individual, comprising:
a device encoded with a QR code to identify an enrolled individual; wherein the enrolled individual has been positively identified;
a reader to read the QR code;
a computer to receive the unique identifier contained within the QR code, a first UI associated with the enrolled individual and a second UI associated with at least one enrolled healthcare service provider; and
the database accessible by the computer to verify the QR code, the first UI and the second UI and to store data related to at least one encounter between the enrolled individual and the at least one enrolled healthcare service provider, and the database configured to be accessed by the computer to recover and output historical data related to the encounter between the enrolled individual and the at least one enrolled health care service provider.

2. The system of claim 1, wherein the at least one enrolled healthcare service provider comprises a plurality of enrolled health care service providers, each of the plurality of enrolled healthcare service providers having a separate and unique UI, each encounter by each of the plurality of enrolled healthcare service providers with the enrolled individual being recorded in the database.

3. The system of claim 1, wherein the stored data related to the at least one encounter includes at least one of: type of service, date, time, location, QR code scanning device ID, QR code scanning device software ID, QR code data, first UI, and second UI.

4. The system of claim 1, wherein the stored data related to the at least one encounter includes at least two of: type of service, date, time, location, QR code scanning device ID, QR code scanning device software ID, QR code data, first UI, and second UI.

5. The system of claim 1, wherein the stored data related to the at least one encounter includes: type of service, date, time, location, QR code scanning device ID, QR code scanning device software ID, QR code data, first UI, and second UI.

6. The system of claim 1, wherein the database stores data related to a plurality of encounters between the enrolled individual and at least one enrolled healthcare service provider.

7. The system of claim 6, wherein the stored data includes: type of service, date, time, location, QR code scanning device ID, QR code scanning device software ID, QR code data, first UI, and second UI.

8. The system of claim 1, wherein the computer comprises a software component to verify the first UI with the unique identifier contained within the QR code, and the second UI.

9. The system of claim 1, wherein the database is configured to be accessed by the computer to recover historical data related to all encounters between the enrolled individual and a plurality of enrolled healthcare service providers.

10. The system of claim 1, wherein the device is selected from the group comprising: a cell phone, a mobile electronic device, a wearable device, a card, a personal ID badge, a wearable electronic device and an electronic watch.

11. A system for providing verification and validation of an identity of at least one enrolled individual, comprising:
a device encoded with a QR code or near-field data to identify an enrolled individual; wherein the enrolled individual has been positively identified biometrically;
a reader to read the QR code or near-field data;
a computer to receive the QR code or near-field data, a first UI associated with the enrolled individual and a plurality of second UIs associated with a plurality of enrolled healthcare service providers; and
the database accessible by the computer to verify the QR code or near-field data, the first UI and the plurality of second UIs and to store data related to a plurality of encounters between the enrolled individual and a plurality of enrolled healthcare service providers, and the database configured to be accessed by the computer to recover and output historical data related to the encounter between the enrolled individual and the plurality of enrolled healthcare service providers.

12. The system of claim 11, wherein each of the plurality of enrolled healthcare service providers has a separate and unique UI, each encounter by the plurality of enrolled healthcare service providers with the enrolled individual being recorded in the database.

13. The system of claim 12, wherein the stored data related to the plurality of encounters includes at least one of: type of service, date, time, location, QR code scanning device ID, QR code scanning device software ID, QR code data, first UI, and second UI.

14. The system of claim 12, wherein the device is selected from the group comprising: a cell phone, a mobile electronic device, a wearable device, a card, a personal ID badge, a wearable electronic device and an electronic watch.

15. The system of claim 11, wherein the database is configured to be accessed by the computer to recover historical data related to all encounters between a plurality of enrolled individuals and a plurality of enrolled healthcare service providers.

16. A method for providing verification and validation of an identity of at least one enrolled individual, comprising:
encoding a device with a QR code to identify an enrolled individual; wherein the enrolled individual has been positively identified;
reading the QR code during an encounter with at least one enrolled healthcare service provider;
receiving at a computer the unique identifier contained within the QR code, a first UI associated with the enrolled individual and a second UI associated with at least one enrolled healthcare service provider; and
accessing a database by the computer to verify the unique identifier contained within the QR code, the first UI and the second UI and to store data related to at least one encounter between the enrolled individual and the at least one enrolled health care service provider, and wherein the database is configured to be accessed by the computer to recover and output historical data related to the encounter between the enrolled individual and the at least one enrolled healthcare service provider.

17. The method of claim 16, wherein the at least one enrolled health care service provider comprises a plurality of enrolled health care service providers, each of the plurality of enrolled health care service providers having a separate UI, each encounter by each of the plurality of enrolled health care service providers with the enrolled individual being recorded in the database.

18. The method of claim 16, wherein the stored data related to the at least one encounter includes at least one of: type of service, date, time, location, QR code scanning device ID, QR code scanning device software ID, QR code data, first UI, and second UI.

19. The system of claim 16, wherein the stored data related to the at least one encounter includes: a type of service, date, time, location, QR code scanning device ID, QR code scanning device software ID, QR code data, first UI, and second UI.

20. A computer program product comprising a non-transitory storage medium embodying the software logic for providing verification and validation of an identity of at least one enrolled individual, the software logic configured that when read and executed by a computer processor, performs the following:
encoding a device with a QR code or near-field data on a user device to identify an enrolled individual; wherein the enrolled individual has been positively identified;
reading the QR code or near-field data during at least one encounter with a plurality of enrolled healthcare service providers;
receiving at a computer the unique identifier contained within the QR code or near-field data, a UI associated with the enrolled individual and a second UI associated with a least one of the plurality of healthcare service providers; and
accessing a database accessible by the computer to verify the QR code or near-field data, the first UI and the second UI and to store data related to at least one encounter between the enrolled individual and the at least one of the plurality of enrolled health care service providers, and wherein the database is configured to be accessed by the computer to recover and output historical data related to the encounter between the enrolled individual and the at least one of the plurality of enrolled health care service providers.
